(19) United States
(12) Patent Application Publication
(10) Pub. No.: US 2015/0176959 A1
(43) Pub. Date: Jun. 25, 2015

(54) METHOD AND MEASURING DEVICE FOR MEASURING THICKNESS OF A FERROMAGNETIC METAL OBJECT

(71) Applicant: Dmitriy Evgenievich AVILOV, Saint Petersburg (RU)

(72) Inventor: Dmitriy Evgenievich AVILOV, Saint Petersburg (RU)

(21) Appl. No.: 14/326,554

(22) Filed: Jul. 9, 2014

(30) Foreign Application Priority Data
Dec. 24, 2013 (EA) 201300133

(51) Int. Cl. G01B 7/06

(52) U.S. Cl. CPC G01B 7/10

(57) ABSTRACT

The invention relates to a method and a device for measuring thickness of ferromagnetic metal objects. According to the method, a pulse of current is generated in a core coil, the core forming a closed magnetic circuit together with at least a portion of the ferromagnetic metal object; further, the time constant is determined at an exponential voltage resulted from said pulse of current generated in the core coil; and, finally, thickness of the ferromagnetic metal object is determined on the basis of the time constant thus determined.

### CROSS-REFERENCE TO RELATED APPLICATIONS

This application claims foreign priority benefit to Eurasian application No 201300133 filed Dec. 24, 2013, which is hereby incorporated by reference in its entirety.

### FIELD OF THE INVENTION

The invention relates to methods and devices for measuring thickness of ferromagnetic metal objects; more particularly, to methods and devices for measuring thickness of ferromagnetic objects using electromagnetic field.

### BACKGROUND OF THE INVENTION

Measuring thickness of objects is essential for many applications. In case an object is accessible for measurements, the direct measurements can be made directly without difficulty; on the contrary, measuring extended objects (for example, sheets of material having edges inaccessible for measurements, or closed objects such as pipe walls) may often get complicated and only indirect measurements can be performed.

Numerous methods and devices are available for indirect thickness measurement, with various principles underlying their operation.

Thus, widely available are acoustic thickness gauges, which excite an acoustic wave in an object being measured and then analyze various parameters of the acoustic wave to determine the thickness.

In general, acoustic gauges measure the transmission time of the acoustic wave reflected from an interface between the object and the air. The transmission time data is then used to determine the wall thickness of the object, for example, using reference data on the speed of acoustic wave propagating through the object's material.

More complicated acoustic gauges are used to improve measurement accuracy.

For example, U.S. Pat. No. 6,883,376 discloses a method for determining the wall thickness and the speed of sound in a tubular workpiece from reflected and transmitted ultrasound pulses. According to the method, an acoustic couplant medium is configured and an ultrasonic transducer is placed in acoustic communication with said medium. Then a transmission path is defined in the medium and a tubular workpiece is disposed in this path. Further, acoustic discontinuities are defined on the interface between the medium and the tubular workpiece. The ultrasonic transducer is then used for transmitting supersonic waves along the transmission path, and at least one of the waves is transmitted without the presence of the workpiece in the transmission path. Then signals are received corresponding both to the fully transmitted waves and to the waves reflected from at least one of the optical discontinuities. The wave transmission time and amplitude data are recorded, and the speed of sound in the tubular workpiece is subsequently determined along with the thickness of each wall.

U.S. Pat. No. 6,883,376 further discloses a system for determining the wall thickness according to the method as described above. Because the speed of sound in a tubular workpiece is calculated in situ rather than taken from the reference data, the measurement results have improved accuracy. Moreover, the proposed method and system can be used for determining thickness of an object made of unknown material.

However, a drawback of the method proposed in U.S. Pat. No. 6,883,376 is complexity of the measurement procedure, which, firstly, requires that a couplant medium be disposed between the workpiece and the transducer to provide acoustic communication therebetween, and, secondly, demands that transmitting supersonic wave be provided along the transmission path both with and without the workpiece disposed in the path.

Magnetic or electromagnetic fields applied to excite the acoustic wave make it possible to do without a couplant medium being disposed between a measuring means and an object measured, which makes the measurements simpler.

For example, U.S. Pat. No. 4,710,712 teaches about a method for measuring thickness of ferromagnetic tubular elements. According to the method, a uniform saturating magnetic field is applied to a tubular element, which means that a further increase in strength of the applied magnetic field would not increase the magnetic field induced in the ferromagnetic tubular element. In other words, the uniform saturated magnetic field is induced in a tubular element, which depends on the tubular element cross-sectional area, i.e., on the wall thickness of the tubular element. Thus, by detecting the magnetic flux generated by the saturated magnetic field in a tubular element, a reading of the wall thickness is produced from the corresponding portion of the tubular element. However, it is essential to note that, according to the method taught, in order to generate a uniform saturated magnetic field of a required strength, a coil having sufficient quantity of windings should be disposed around the tubular element to pass the direct current through the coil, which means that a complicated device layout has to be used. Besides, a significant amount of energy is required to generate the saturated magnetic field of sufficient strength. Finally, the resultant reading of wall thickness is averaged over the area covered by the coil, i.e., over the perimeter of the tubular element. Therefore, local variations in the wall thickness may remain undetected.

The closest prior art to the present invention is a means for ultrasonic inspection of pipes disclosed in a utility model patent RU 66547. A key element of said means is an electromagnetic acoustic transducer, which comprises a magnetic system containing permanent magnets made of Nd—Fe—B-based alloy and a high-frequency coil disposed directly under the magnetic system. The electromagnetic acoustic transducer acts as both radiator and receiver of the acoustic wave. The means for ultrasonic inspection realize the following method for measuring thickness of an object.

With the electromagnetic acoustic transducer being placed in contact with an object measured, the object gets magnetized because of the magnetic system action. Then alternating current is applied to the high frequency coil, which, in particular, results in the electromagnetic field being induced in the object at a constant amplitude of magnetic induction, the field propagating into at least a portion of the object in the direction of measurement; and the alternating current also leads to the formation of high-frequency eddy currents. Because the forces of magnetic interaction between eddy currents and applied field are parallel to the object's surface, a transverse supersonic wave (SH-wave) is generated in the object. Said SH-wave is reflected from interface between the object and the air. The reflected wave is received with the electromagnetic acoustic transducer; and thickness of the object, i.e., the pipe wall thickness is read by analyzing the reflected signal.

Because the acoustic wave is excited in the object by induction of the electromagnetic field, the described means do not require a couplant medium to be used for providing acoustic communication between the means and the object being measured, with the means having moderate energy consumption. However, the need for transformation of electromagnetic energy into acoustic energy and vice versa, complicates manufacturing and maintenance of the means described.

Considering that thickness measurements often have to be performed under challenging conditions, such as measuring wall thickness of active pipelines, an issue of how to make measurement devices simpler becomes vital. Moreover, pipes are mostly made of ferromagnetic material, which therefore calls for the development of means for measuring thickness of ferromagnetic metal objects.

Therefore, though numerous devices and methods are available for indirect thickness measurements, new methods for measuring thickness of ferromagnetic metal objects still need to be developed to further ease measurement; and new devices realizing these methods need to be designed to improve manufacturability and maintainability thereof.

### DISCLOSURE OF THE INVENTION

It is an object of the present invention to provide a method for indirect thickness measurements of ferromagnetic metal objects, which ensures measurement simplicity; it is a further object of the present invention to provide a measuring device that implements the proposed method and is easy to manufacture and to maintain.

First of the foregoing objects is achieved by a method for measuring thickness of a ferromagnetic metal object, wherein a pulse of current is generated in a core coil, the core forming a closed magnetic circuit together with at least a portion of the ferromagnetic metal object; further, the time constant is determined at an exponential voltage resulted from said pulse of current generated in the core coil; and, finally, thickness of the ferromagnetic metal object is determined on the basis of the time constant.

The effect of the invention is that thickness of a ferromagnetic metal object can be measured either when the core directly contacts the ferromagnetic object or when the core is distant from the ferromagnetic object. Said distance can range preferably from 1 mm to 10 mm; however, other distances can be considered.

In one embodiment of the proposed method, the distance between the core and the ferromagnetic metal object is measured by a gap magnetic sensor.

The second of the forgoing objects is achieved by a measuring device for measuring thickness of a ferromagnetic metal object, said device comprising a core configured to form a closed magnetic circuit together with at least a portion of the ferromagnetic metal object Further, the device comprises a core coil configured to generate a pulse of current therein. Finally, the device comprises means to determine the time constant of an exponential voltage pulse generated in the core coil as a result of generation of the current pulse in the coil.

In one of the embodiments, the measuring device additionally contains a gap magnetic sensor connected to the core and configured to measure a distance between the core and the ferromagnetic metal object.

In another embodiment of the measuring device, the core and the magnetic sensor are connected by epoxy resin.

In yet another embodiment of the measuring device, the core is U-shaped.

### BRIEF DESCRIPTION OF THE DRAWINGS

Further, embodiments of the invention are disclosed in detail with reference to the appended drawings in which:

FIG. 1 is a three-dimensional illustration of a core and an object to be measured, according to the present invention;

FIG. 2 is an illustration of one of the embodiments wherein the core is placed in direct contact with the measured object;

FIG. 3 is an illustration of the principle of operation of the measuring device for measuring thickness of a measured metal object according to one of the embodiments, wherein the core is placed in direct contact with the measured object;

FIG. 4 illustrates one of the embodiments of the present invention, wherein there is an air gap between the core and the measured object;

FIG. 5 is an illustration of the principle of operation of a measuring device for measuring thickness of a metal object according to one of the embodiments, wherein there is an air gap between the core and the measured object; and

FIG. 6 illustrates an appearance of a core having a coil and a gap magnetic sensor according to an embodiment of the present invention.

### DETAILED DESCRIPTION OF THE INVENTION

The present invention will be understood from the following description taken with reference to the attached drawings, with the same reference numbers allocated to common components in the embodiments.

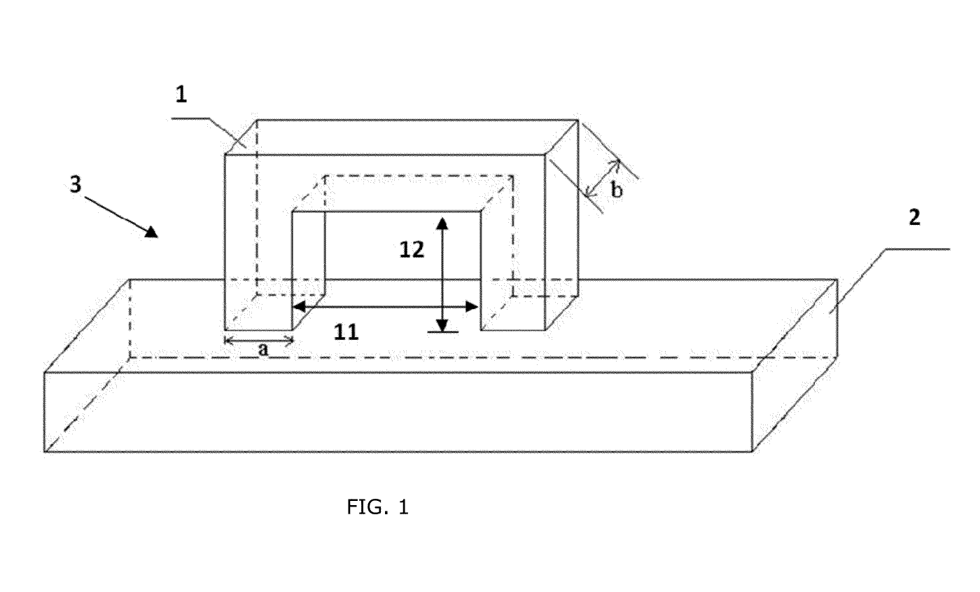

FIG. 1 illustrates a measuring device 3 for measuring thickness of a ferromagnetic metal object 2, the device comprising at least: a core 1, in particular a U-shaped ferrite core, having a coil wound thereon (not shown), with the core forming a closed magnetic circuit with at least a portion of the metal object 2. The measuring device 3 further comprises a current source (not shown) connected to the coil, and also connected to the coil are determining means intended for determining at least one parameter of the exponential voltage pulse (for example, a reading of its time constant) and for determining thickness of a measured object on the basis of the readings of exponential voltage time constant.

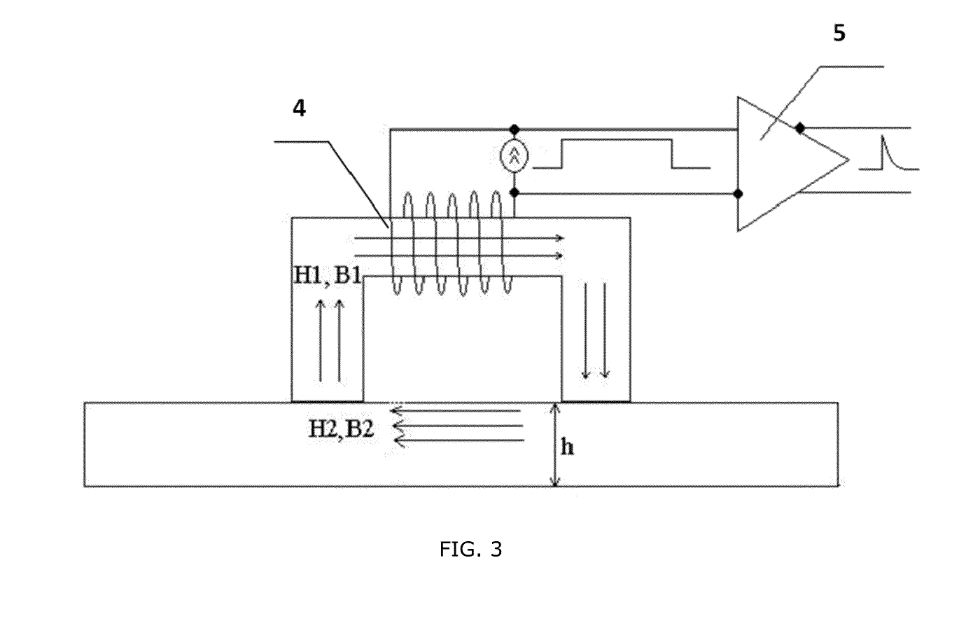

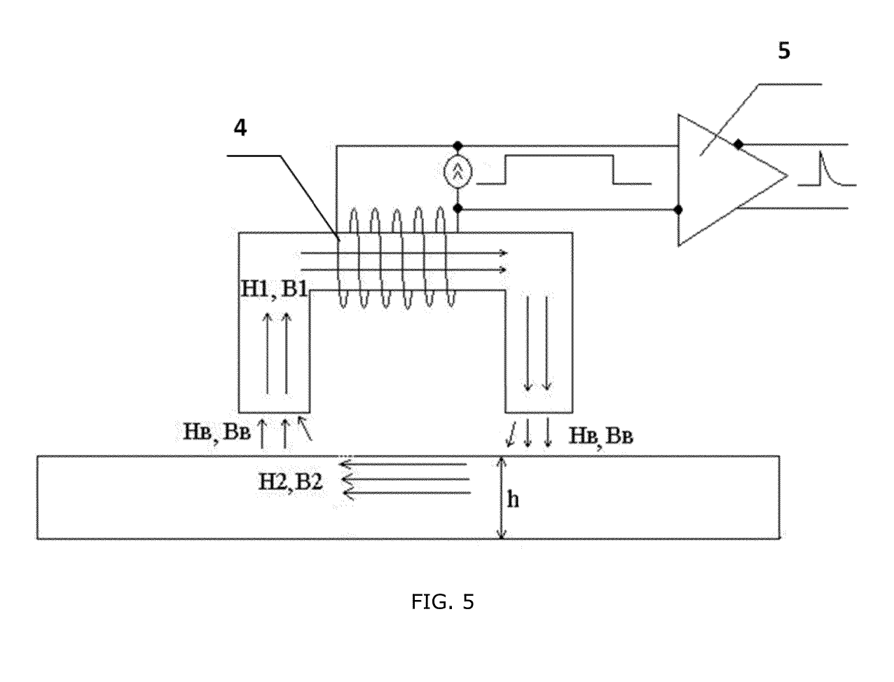

According to an embodiment of the present invention, the determining means include an amplifier 5 (FIGS. 3, 5), means (not shown) for determining the time constant of an exponential voltage pulse and means (not shown) for determining thickness of a measured object on the basis of the exponential voltage pulse time constant. The means for determining the time constant and/or the means for determining thickness of a measured object can for example be in the form of an electronic circuit on a printed board, an electronic computer, etc.

The amplifier input is connected to a coil 4, and the amplifier 5 amplifies the input signal received from the core coil. The output of the amplifier 5 is connected to the means for determining the time constant, which are also connected to the means for determining thickness of a measured object.

According to another embodiment of the present invention, determining means include an analog-to-digital converter ADC (not shown) that converts an analog signal into a digital signal, and is connected between the amplifier 5 and the means for determining the time constant, or between the means for determining the time constant and the means for determining thickness of a measured object.

According to another embodiment of the present invention, the measuring device further comprises a controlling device (not shown) to control the measuring device. The controlling device can be connected to the means for determining the time constant and/or to the means for determining thickness of an object; said controlling device is configured to input at least one parameter of the measuring device and/or of the measured object, for example, a permeability coefficient or another parameter. In addition, the controlling device can be connected to a current source to provide setting of at least one parameter of the pulse of current that is formed in the core coil by the source current: for example, amplitude, pulse duration or another parameter of the pulse of current. The controlling device can be in the form of an electronic circuit on a printed board, an electronic computer device, etc., or it can contain input features such as a keyboard.

According to one embodiment of the present invention, the measuring device further comprises a display device (not shown), which is connected to at least one of the components selected from: means for determining the time constant, means for determining thickness of an object, and a controlling device; said display device is configured to display a reading of the thickness of a measured object and/or a reading of the time constant of an exponential voltage pulse. The display device can be in the form of a digital display and/or an analog display.

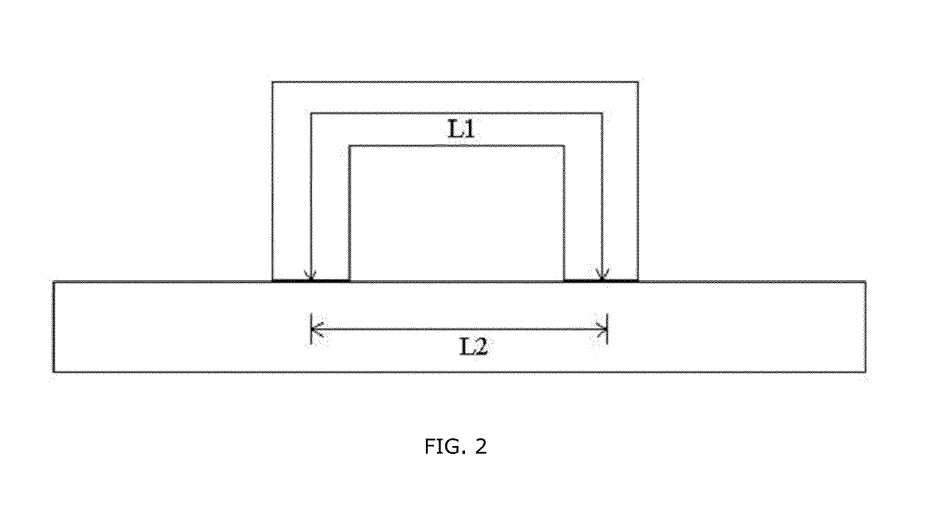

FIGS. 2, 3 illustrate one of the embodiments of the present invention, wherein a core is placed in direct contact with a measured object. Referring now to FIG. 2, a magnetic circuit is formed by a core 1 having a coil, particularly, the U-shaped ferrite core 1, and a measured metal object 2, particularly, the ferromagnetic metal object 2. Said magnetic circuit thus formed is divided into two sections: the first section of the magnetic circuit corresponds to the core 1 having a coil 4; and the second section of the magnetic circuit corresponds to the measured metal object 2. H1 and B1 are, respectively, the strength and the induction of the magnetic field in the core 1; H2 and B2 are, respectively, the strength and the induction of the magnetic field in the measured metal object 2 directly (FIG. 3).

According to the Ampere's circuital law:

H1·L1+H2·L2=I·N,

where L1 is the length of the first section; L2 is the length of the second section; I is the complex amplitude of current in the coil 4 of the core 1; and N is the quantity of windings in the coil 4 of the core 1.

In a specific embodiment of the present invention, the core can be, for example, 90 mm in height, 100 mm in length, the length of the bridge 11 can amount to 33 mm, and the height of the legs 12 can be 53.5 mm (FIG. 1).

To simplify the calculations, assume that the entire magnetic field is confined within a closed magnetic circuit, and said magnetic circuit has no branches, then it can be written down that

φ1=φ2=φ,

where φ1 is the magnetic flux of induction in the core 1; φ2 is the magnetic flux in the measured metal object 2; and φ is the total magnetic flux in the magnetic circuit.

Considering that φ1=B1·S1, φ2=B2·h·b,

where S1 is the circuit surface area corresponding to the core 1 section area through which the magnetic flux φ1 is flowing (in this embodiment, the core has a rectangular section, however, in other embodiments the section can be circular, square, or of any other shape),

h is thickness of a measured metal object 2, b is an overall size of the core 1 (for example, 34 mm) (FIG. 1);

and further considering that H1=B1/μ1·μ0, H2=B2/μ2·μ0, where μ0 is the magnetic constant, μ1 is the permeability of the core, and μ2 is the permeability of the measured object,

the value of magnetic flux can be derived from the above equations as

$$Φ = \frac{I \cdot N}{\frac{L 1}{{μ}_{0} \cdot {μ}_{1} \cdot a \cdot b} + \frac{L 2}{{μ}_{0} \cdot {μ}_{2} \cdot b \cdot h}}$$

Further considering that the inductance L is by definition the ratio of the magnetic linkage to the current

L=φ·N/I,

the inductance of the core 1 disposed above the measured metal object 2 can be expressed as

$$L = \frac{{N}^{2}}{\frac{L 1}{{μ}_{0} \cdot {μ}_{1} \cdot a \cdot b} + \frac{L 2}{{μ}_{0} \cdot {μ}_{2} \cdot b \cdot h}}$$

where a is another overall size of the core 1 (for example, 34 mm) (FIG. 1).

The time constant of a voltage pulse on the core 1 equals the ratio of the inductance of core 1 to the resistance of the measured metal object 2, i.e.,

τ=L/R,

where R is the resistance of the measured metal object 2.

The resistance of metal object 2 can be expressed as

R=L2·ρ/(b·h),

where ρ is the resistivity of the metal object material.

From the last three equations, the time constant can be derived as

$$τ = \frac{{N}^{2} \cdot b \cdot \frac{h}{ρ}}{( \frac{L 1}{{μ}_{0} \cdot {μ}_{1} \cdot a \cdot b} + \frac{L 2}{{μ}_{0} \cdot {μ}_{2} \cdot b \cdot h} ) \cdot L 2}$$

The overall sizes of core 1 are selected so that for h>1 mm the following inequality is satisfied:

$$\frac{L 1}{{μ}_{0} \cdot {μ}_{1} \cdot a \cdot b} > \frac{L 2}{{μ}_{0} \cdot {μ}_{2} \cdot b \cdot h}$$

Then the following is true:

$$τ = \frac{{N}^{2} \cdot b \cdot \frac{h}{ρ}}{\frac{L 1}{{μ}_{0} \cdot {μ}_{1} \cdot a \cdot b} \cdot L 2}$$

$$h = \frac{ρ \cdot τ \cdot L 2 \cdot \frac{L 1}{{μ}_{0} \cdot {μ}_{1} \cdot a \cdot b}}{{N}^{2} \cdot b}$$

From the last expression, it is clear that the measured thickness of metal object 2 is proportional to the time constant of an exponential voltage pulse in the core 1.

Means for determining thickness of an object can particularly determine thickness on the basis of the above cited equation recorded in their memory.

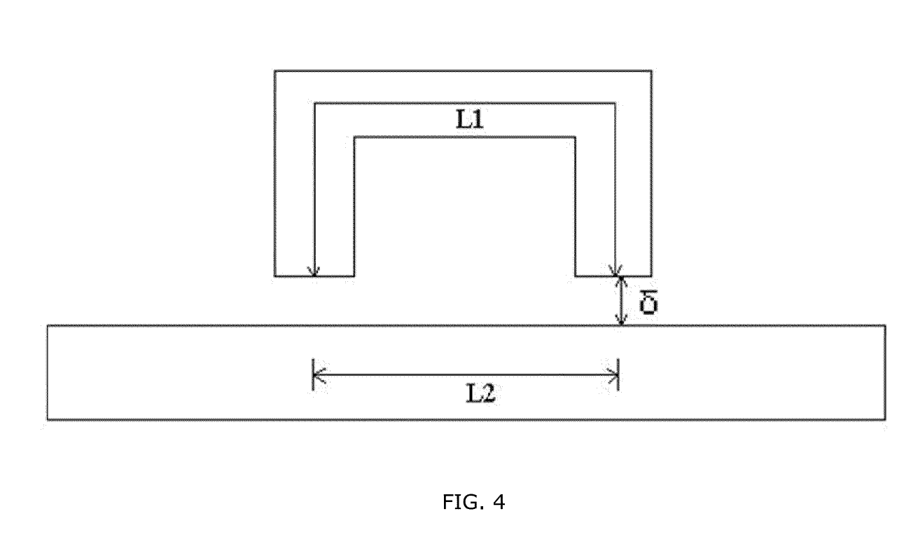

FIGS. 4 & 5 illustrate another embodiment of the present invention, where there is an air gap between the core and the measured object. FIG. 4 displays a magnetic circuit formed by a core 1 with a coil, particularly, the U-shaped ferrite core 1, and a metal object 2, particularly, the ferromagnetic metal object 2. Said magnetic circuit is divided into four sections: the first section of the magnetic circuit corresponds to the core 1 with a coil 4; the second section of the magnetic circuit corresponds to the measured object 2; the third section and the fourth section of the magnetic circuit correspond to the gap between the core 1 and the measured object 2. H1 and B1 are, respectively, the strength and the induction of the magnetic field in the core 1; H2 and B2 are, respectively, the strength and the induction of the magnetic field directly in the measured object 2; and H_{B} B_{B} are, respectively, the strength and the induction of the magnetic field in the air gaps between the core 1 and the measured object 2 (see FIG. 5).

From the Ampere's circuital law, it is derived for the magnetic circuit that:

H1·L1+H_{B}·δ+H2·L2+H_{B}·δ=I·N,

where L1 is the length of the first section; L2 is the length of the second section; δ corresponds to the length of the third and fourth sections (see FIG. 2); I is the complex current amplitude in the coil 4 of core 1; and N is the quantity of windings in the coil 4 of core 1. In a specific embodiment of the present invention, the core can be 90 mm in height, 100 mm in length; the length of the bridge 11 can amount to 33 mm, and the height of legs 12 can be 53.5 mm (FIG. 1).

To simplify the calculations, assume that the entire magnetic field is confined within a closed magnetic circuit, and said magnetic circuit has no branches, then it can be written down that

φ1=φ2=φ_{B}=φ,

where φ₁ is the magnetic flux of induction in the core 1; φ2 is the magnetic flux in the measured metal object 2;

φ_{B} is the magnetic flux in the air gaps between the core 1 and the measured object 2; and φ is the total magnetic flux in the magnetic circuit.

Considering that φ1=B1·S1, φ2=B2·h·b, φ_{B}≈B_{B}·S1,

where S1 is the circuit surface area corresponding to the section area of core 1 and of the air gaps, through which the magnetic fluxes φ1 and φ_{B} are flowing (in this embodiment, the core has a rectangular section, however, in other embodiments the section can be circular, square, or of any other shape), h is thickness of the measured metal object 2, b is an overall size of the core 1 (for example, 34 mm) (see FIG. 1),

and further considering that H1=B1/μ1·μ0, H2=B2/μ2·μ0, where μ0 is the magnetic constant, μ1 is the permeability of the core, and μ2 is the permeability of the measured object,

the value of magnetic flux can be derived from the above equations as

$$Φ = \frac{I \cdot N}{\frac{L 1}{{μ}_{0} \cdot {μ}_{1} \cdot a \cdot b} + \frac{2 δ}{{μ}_{0} \cdot a \cdot b} + \frac{L 2}{{μ}_{0} \cdot {μ}_{2} \cdot b \cdot h}}$$

Further considering that the inductance L is by definition the ratio of the magnetic linkage to the current

L=φ·N/I,

the inductance of the core 1 disposed above the measured metal object 2 can be expressed as

$$L = \frac{{N}^{2}}{\frac{L 1}{{μ}_{0} \cdot {μ}_{1} \cdot a \cdot b} + \frac{2 δ}{{μ}_{0} \cdot a \cdot b} + \frac{L 2}{{μ}_{0} \cdot {μ}_{2} \cdot b \cdot h}}$$

where a is another overall size of the core 1 for example, 34 mm) (FIG. 1).

With a small gap between the core 1 and the measured metal object 2, the time constant of a voltage pulse on the core 1 equals the ratio of the inductance of core 1 to the resistance of a measured metal object 2, i.e.,

τ=L/R,

where R is the resistance of the measured metal object 2.

Preferably, the distance between the core 1 and the measured metal object 2 is the same on either of the sections of the magnetic circuit, being, for example of 1 mm to 10 mm.

The resistance of metal object 2 can be expressed as

R=L2·ρ/(b·h),

where ρ is the resistivity of the metal object material.

From the last three equations, the time constant can be derived as

$$τ = \frac{{N}^{2} \cdot b \cdot \frac{h}{ρ}}{( \frac{L 1}{{μ}_{0} \cdot {μ}_{1} \cdot a \cdot b} + \frac{2 δ}{{μ}_{0} \cdot a \cdot b} + \frac{L 2}{{μ}_{0} \cdot {μ}_{2} \cdot b \cdot h} ) \cdot L 2}$$

The overall sizes of core 1 are selected so that for h>1 mm the following inequality is satisfied:

$$\frac{L 1}{{μ}_{0} \cdot {μ}_{1} \cdot a \cdot b} + \frac{2 δ}{{μ}_{0} \cdot a \cdot b} > \frac{L 2}{{μ}_{0} \cdot {μ}_{2} \cdot b \cdot h}$$

Then the following is true:

$$τ = \frac{{N}^{2} \cdot b \cdot \frac{h}{ρ}}{( \frac{L 1}{{μ}_{0} \cdot {μ}_{1} \cdot a \cdot b} + \frac{2 δ}{{μ}_{0} \cdot a \cdot b} ) \cdot L 2}$$

$$h = \frac{ρ \cdot τ \cdot L 2 \cdot ( \frac{L 1}{{μ}_{0} \cdot {μ}_{1} \cdot a \cdot b} + \frac{2 δ}{{μ}_{0} \cdot a \cdot b} )}{{N}^{2} \cdot b}$$

From the last expression, it is clear that the measured thickness of metal object 2 is proportional to the time constant of an exponential voltage pulse in the core 1.

Means for determining thickness of an object can particularly determine thickness on the basis of the above cited equation recorded in their memory. Besides, means for determining thickness of an object can have more than one equation recorded in their memory, for example, equations corresponding to various mutual arrangements of object and core.

Thickness of a metal object 2 is measured as follows.

In the coil of the core 1, a pulse of current is formed, having a certain amplitude and a certain duration, using a current source. The value of desired signal depends on the current pulse amplitude: the greater the amplitude, the greater the value of desired signal; however, if the amplitude grows too high, saturation of the core 1 may occur. For example, the amplitude can range as 300-400 mA. Pulse duration is selected considering thickness of the core 1: for example, the pulse duration can be 1 sec.

After the pulse decay, an exponential voltage pulse occurs at the coil ends. Then the exponential pulse voltage time constant is determined using the determining means. The exponential pulse time constant is proportional to the resistance of the metal object 2 volume under the core 1, with said resistance being proportional to thickness of the measured object 2.

Therefore, by measuring the exponential voltage pulse time constant in the core 1, one can determine thickness of the measured metal object 2 on the basis of said time constant.

Measurement results can be displayed using a display device.

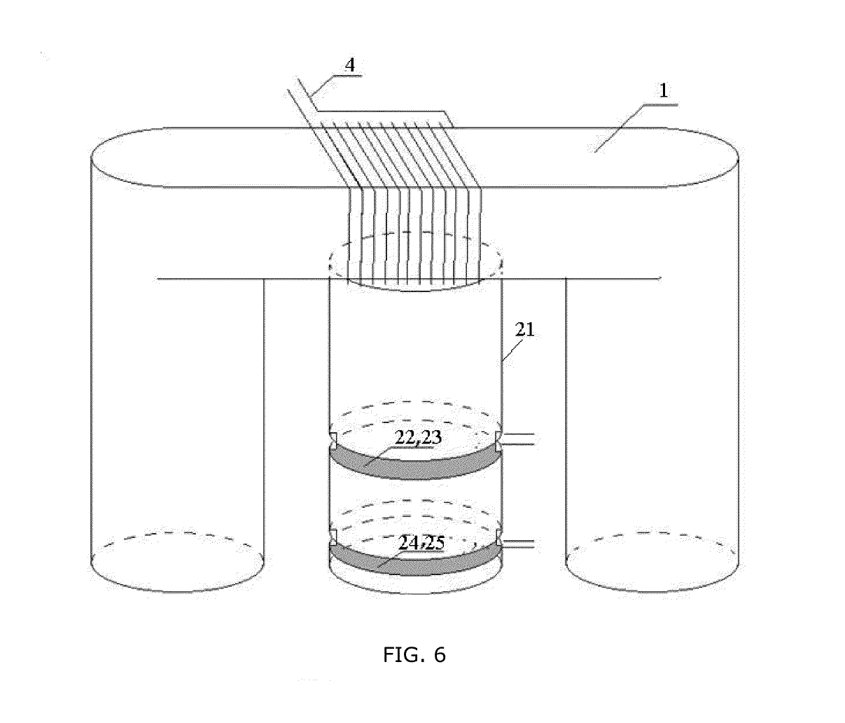

FIG. 6 shows an appearance of another embodiment of the present invention, wherein a measuring device 3 comprises a core 1 having a coil 4, and further comprises a known gap magnetic sensor 21 to determine the gap between the core 1 and a measured object 2. In a specific embodiment, the gap magnetic sensor is configured as a plastic cylinder of a diameter of, for example, 30 mm, having four windings. The section of core 1 illustrated in FIG. 6 is not to be interpreted as limiting either the scope of the specified embodiment or the entire scope of the present invention.

The coil 3 is made of magnet wire containing at least an electric conductor: for example, a <<PESHO-0.22>> magnet wire [having enameled fiber insulation and a single coil of silk threads of 0.22 mm in the copper conductor cross-section], having 80 windings.

The coils 22, 23, 24, 25 of the gap magnetic sensor 21 are made using magnet wire, for example, a <<PETV-0.1>> magnet wire [having high-strength heat-resisting enamel coating and being of 0.1 mm in the copper conductor cross-section], with each coil comprising, for example, 200 windings. In one of the embodiments of the present invention, the core 1 and the gap magnetic sensor 20 are connected using epoxy resin. The distance between the pairs of coils 22, 24 and 23, 25 can be, for example, 7 mm.

The description above is provided to serve as an example and should not be construed as limiting the scope of the invention. Those skilled in the art would be able to understand possible variations and modifications to the disclosed embodiments without departing from the essence of the present invention.

All distances, overall sizes and other numerical values encountered in the present specification are given as illustrative examples only and are not intended for limiting the scope of the present invention; and possible errors in the numerical values can be simulated and avoided programmatically.

1. A method for measuring thickness of a ferromagnetic metal object comprising the steps below:
generating a pulse of current in a core coil, the core forming a closed magnetic circuit together with at least a portion of the ferromagnetic metal object;
determining the time constant of an exponential voltage pulse generated in the core coil as a result of said pulse of current applied;
determining thickness of the ferromagnetic metal object on the basis of the determined time constant.

2. The method of claim 1, further comprising measuring a distance between said core and the ferromagnetic metal object by means of a gap magnetic sensor, wherein measuring thickness of the ferromagnetic metal object is carried out in view of the distance thus measured.

3. A measuring device for measuring thickness of a ferromagnetic metal object, the device comprising:
a core configured to form a closed magnetic circuit together with at least a portion of the ferromagnetic metal object;
a core coil configured to form a pulse of current therein; and
means to determine the time constant of an exponential voltage pulse generated in the coil as a result of the current pulse formation in the coil.

4. The measuring device of claim 3 further comprising a gap magnetic sensor connected to said core and configured to measure a distance between the core and the ferromagnetic metal object.

5. The measuring device of claim 4, wherein the core and the magnetic sensor are connected by epoxy resin.

6. The measuring device of claim 4, wherein the core is U-shaped.
